(19) United States
(12) Patent Application Publication
(10) Pub. No.: US 2014/0175705 A1
(43) Pub. Date: Jun. 26, 2014

(54) MANUFACTURING METHOD FOR SUBSTRATE

(71) Applicant: NGK Spark Plug Co., Ltd., Nagoya (JP)

(72) Inventor: Yousuke MORITA, Chino-shi (JP)

(73) Assignee: NGK Spark Plug Co., Ltd., Nagoya (JP)

(21) Appl. No.: 14/136,872

(22) Filed: Dec. 20, 2013

(30) Foreign Application Priority Data
Dec. 21, 2012 (JP) 2012-280141
Dec. 11, 2013 (JP) 2013-255822

(51) Int. Cl. B29C 59/16

(52) U.S. Cl. CPC B29C 59/16
USPC 264/400

(57) ABSTRACT

A method for manufacturing a substrate includes manufacturing a substrate with an identifying mark having a plurality of elements, the substrate having a laminated construction including a plurality of resin insulating layers. The method includes the steps of: forming a first element of the identifying mark by irradiating the substrate with a laser to create a first plurality of projections in parallel at equal intervals; and forming another element of the identifying mark by irradiating the substrate with a laser to create a second plurality of projections in parallel at equal intervals that do not overlap the first plurality of projections.

### CROSS-REFERENCE TO RELATED APPLICATION

This application claims priority to Japanese Patent Application No. 2012-280141, which was filed with the Japan Patent Office on Dec. 21, 2012, and to Japanese Patent Application No. 2013-255822, which was filed with the Japan Patent Office on Dec. 11, 2013, the entire contents of which are hereby incorporated by reference.

### BACKGROUND OF THE INVENTION

1. Field of the Invention

The present invention relates to a method for manufacturing a substrate by irradiating the substrate with a laser, the substrate having a laminated construction including a plurality of resin insulating layers.

2. Description of Related Art

In the related art, there is known a substrate for mounting parts such as an IC chip. In this kind of substrate, a solder resist is formed so as to cover a substrate main surface of the substrate. Moreover, a mark (such as a character or characters) to identify the substrate type is generally provided on a surface of the solder resist.

For example, the mark may be provided by laser marking, printing by the use of an ink jet printer, or attaching of a sticker that shows the substrate type with respect to an ink layer formed on the surface of the solder resist. However, in the case of performing laser marking with respect to the ink layer, it is necessary to prepare ink for ink layer formation. Moreover, it is necessary to form the ink layer separately from the laser marking. Therefore, the manufacturing cost increases. Similarly, even in the case of performing the printing by the use of the ink jet printer, it is necessary to prepare ink. Therefore, the manufacturing cost increases. Moreover, in the case of attaching a sticker, since it is necessary to prepare the sticker, the manufacturing cost increases. Therefore, in recent years, a laser marking method to form a marking portion (such as a character and a mark) at low cost is suggested by directly performing laser marking on the surface of the solder resist.

The laser marking methods suggested in the related art are classified into three techniques of (1) surface layer separation, (2) printing surface separation and (3) color development. In the technique of (1) surface later separation, a marking portion is formed by digging a character in a solder resist. Moreover, in the technique of (2) printing surface separation, a metallic layer such as a copper layer is formed as a base layer of a solder resist. A marking portion (recognition mark) is formed by exposing the metallic layer by laser machining processing (for example, see JP-A-2003-51650). Further, in the technique of (3) color development, a marking portion is formed with the color development by foaming a resist member by generating heat in the laser marking method. This technique can be acquired excellent visibility in the marking portion by not deep processing, unlike the techniques of surface layer separation, but by foaming the solder resist up to a deep part.

### BRIEF SUMMARY OF THE INVENTION

A method for manufacturing a substrate includes manufacturing a substrate with an identifying mark or character having a plurality of elements by irradiating a laser to the substrate (i.e., irradiating the substrate with a laser, or laser etching the substrate), the substrate having a laminated construction including a plurality of resin insulating layers. The method includes the steps of: forming one element (i.e., a first element) of the identifying mark including a plurality of projections (i.e., a first plurality of projections) in parallel at equal intervals by irradiating the laser (i.e., irradiating the substrate with the laser); and forming another element of the identifying mark with a plurality of projections (i.e., a second plurality of projections) in parallel at equal intervals to avoid overlapping with the plurality of projections (i.e., the first plurality of projections) by irradiating the laser (i.e., irradiating the substrate with the laser).

### BRIEF DESCRIPTION OF THE DRAWINGS

Illustrative aspects of the invention will be described in detail with reference to the following figures wherein:

FIG. 1 is a schematic plan view that shows a wiring substrate in the present embodiment;

FIG. 2 is a schematic sectional view that shows a wiring substrate;

FIG. 3 is an explanatory view that shows an identifying mark in a marking portion of the substrate;

FIG. 4 is a sectional view of a portion of the substrate through the Z-Z line in FIG. 3;

FIG. 5 is a schematic configuration view that shows a laser machining processing device;

FIG. 6 is a plan view that shows a substrate tray;

FIG. 7 is a sectional view that shows a schematic configuration of a laser machining processing portion;

FIG. 8 is an explanatory view that shows a formation method of elements forming an identifying character;

FIG. 9 is an explanatory view that shows a formation method of elements forming an identifying character;

FIG. 10 is an explanatory view that shows the processing degree of a normal identifying character;

FIG. 11 is an explanatory view that shows the processing degree of an identifying character according to the invention;

FIG. 12 is an explanatory view in the case of processing while shifting the laser focus from the surface of a wiring substrate to the optical source side;

FIG. 13 is an explanatory view that shows the relationship between the focus depth and processing depth of a laser;

FIG. 14 is a view that expands and shows an identifying character and part of its elements in a wiring substrate of another embodiment;

FIG. 15 is a partial sectional view of a plane through the A-A line in the identifying character elements of FIG. 14; and

FIG. 16 is a partial sectional view of a plane through the B-B line in the identifying character elements of FIG. 14.

### DETAILED DESCRIPTION OF EXEMPLARY EMBODIMENTS OF THE INVENTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, the above mentioned laser marking methods of (1) to (3) caused following problems. In the technique of (1) surface layer separation in the above-mentioned laser marking method, the thickness of a resist itself in a marking portion decreases. Therefore, strict processing accuracy is required to form the marking portion while maintaining a function of the solder resist, and, as a result, the manufacturing cost increases.

Moreover, in the technique of (2) printing surface separation, a dedicated special design suitable for the formation of the marking portion, that is, a design to embed a base member of a color tone different from a surface substrate such as a metallic layer presumed to be exposed is done. As a result, the manufacturing cost increases. Further, if a copper layer is exposed in the marking portion, there is concerned a problem that erosion occurs from the part and the solder resist is separated off.

Moreover, in the technique of (3) color development, the solder resist is foamed up to the deep part to secure the visibility. Therefore, many bubbles are generated in the resist. As a result, physical vulnerability is caused in the solder resist. Therefore, there is an increasing possibility that the solder resist is collapsed or separated off. Therefore, an applicable range in the solder resist is limited in the formation of the marking portion by color development.

Further, when a high temperature of about 200° C. is added to the marking portion (processing portion) formed by the color development, the bubbles in the resist are removed, and the color development of the marking portion disappeared. Especially, the visibility of the marking portion deteriorates and the quality of the marking portion decreases as for the heating in the solder reflow, when parts such as an IC chip are mounted on a wiring substrate by the solder reflow to exceed 200° C.

An object of the present invention is to solve the problem described in the section Related Art and to provide a substrate manufacturing method that can efficiently manufacture a substrate with high reliability at low cost.

A method for manufacturing a substrate according to a first aspect of the present invention (the first manufacturing method) includes manufacturing a substrate with an identifying mark having a plurality of elements, the substrate having a laminated construction including a plurality of resin insulating layers. The method includes the steps of: forming a first element (one element) of the identifying mark by irradiating the substrate with a laser to create a first plurality of projections in parallel at equal intervals; and forming another element of the identifying mark by irradiating the substrate with a laser to create a second plurality of projections in parallel at equal intervals that do not overlap the first plurality of projections. Of course, one of skill in the art will recognize that the method can also include forming as many additional elements as are required to complete the identifying mark by equivalent steps.

A method for manufacturing a substrate according to a second aspect of the present invention (the second manufacturing method) includes manufacturing a substrate with an identifying mark having a plurality of elements, the substrate having a laminated construction including a plurality of resin insulating layers. The method includes the steps of: forming a first element of the identifying mark by irradiating the substrate with a laser to create a first plurality of protrusion lines in parallel at equal intervals including a plurality of sequential protrusion portions; and forming another element of the identifying mark by irradiating the substrate with a laser to create a second plurality of protrusion lines in parallel at equal intervals that do not overlap the first plurality of protrusion lines.

According to the first manufacturing method and the second manufacturing method, the first element includes a plurality of projections or protrusion lines in parallel at equal intervals is formed by irradiating a laser. The other element includes a plurality of projections or protrusion lines in parallel at equal intervals is formed so as not to be overlapped with the plurality of projections or protrusion lines of the first element. Also, the identifying mark including these plural elements is formed on the surface of a resin insulating layer.

In the case of forming the identifying mark in this method, the plurality of projections and protrusion lines forms fine concavity and convexity on the surface of each element. Further, light is scattered by the concavity and convexity. As a result, it is possible to sufficiently secure the visibility of the identifying mark. Moreover, there is no overlapping processing portion between elements. Therefore, a part subjected to concavo-convex processing is a part with a shallow surface. Therefore, damage to the deep part of a resin insulating layer due to heat generated by processing is avoided (or suppressed). Therefore, even in a case where a font is formed on the surface of the resin insulating layer, it is possible to avoid (or suppress) the decline in the functions (insulation properties and heat resistance) of the resin insulating layer. As a result, it is possible to secure the reliability of a manufactured substrate.

Moreover, in the first manufacturing method and the second manufacturing method, a specific design to embed a metallic layer as a base member is not required, unlike a conventional technique of printing surface separation. Therefore, it is possible to efficiently manufacture a substrate with high reliability at low cost.

In the step of irradiating the laser, the laser may be irradiated to a surface layer portion of a resin insulating layer of an outermost layer to foam and raise a surface of the resin insulating layer of the outermost layer and form the plurality of projections or the plurality of protrusion lines. A foaming bubble is confined in the projections or protrusion lines formed in this method. Light is scattered by the foaming bubble, and the projections or protrusion lines may be discolored. Therefore, it is possible to further enhance the visibility.

The laser may be irradiated in two or more batches to form the plurality of projections in parallel at equal intervals or the plurality of protrusion lines in parallel at equal intervals. Thus, when the laser is irradiated in two or more batches, it is possible to avoid (or suppress) damage to the deep part of the resin insulating layer due to heat generated by processing and reliably form the plurality of projections or protrusion lines on the surface layer portion.

Laser irradiation may also be repeatedly performed on the projections or protrusion lines of the elements, and the same number of executions of the laser irradiation may be performed on each of the projections or the protrusion lines. By repeating the laser irradiation in this method, it is possible to form the protrusions or protrusion lines having sufficient height. Moreover, by causing the same number of executions of the laser radiation on each projection or protrusion line, it is possible to reliably form the projections or protrusion lines in the uniform processing degree. Therefore, it is possible to avoid (or suppress) that it is difficult to partially see an element that forms an identifying mark. As a result, it is possible to accurately recognize the identifying mark.

The projections or protrusion lines may be formed in a linear (i.e., straight) shape. In this case, it is possible to form the plurality of projections or protrusion lines in parallel at equal intervals, in a relatively easy and accurate manner. Moreover, it is possible to uniformly form each identifying mark in the same processing degree. Therefore, it is possible to sufficiently secure the substrate appearance quality.

The height of a projection or a protrusion portion forming a protrusion line may be formed to be equal to or greater than 1.5 μm and equal to or less than 6.5 μm. When the height of the projection or protrusion portion is less than 1.5 μm, the font visibility decreases. Moreover, when the height of the projection or protrusion line is greater than 6.5 μm, the influence of heat generated by laser machining processing on a resin insulating layer increases, and there is fear that the functions (insulation properties and heat resistance) of the resin insulating layer decline. Therefore, when the height of the projection or protrusion portion is equal to or greater than 1.5 μm and equal to or less than 6.5 μm, it is possible to ensure the reliability of a substrate to be manufactured.

The resin insulating layer of the outermost layer may be a colored solder resist. In this case, it is possible to form a plurality of projections or protrusion lines forming an element of a font, on the surface of the solder resist while holding the functions of insulation properties and heat resistance of the solder resist. Moreover, light is scattered by the concavity and convexity of the plurality of projections or protrusion lines in the solder resist. Therefore, the identifying mark has a white turbid appearance as compared with the surroundings. As a result, it is possible to sufficiently secure the visibility. Here, the solder resist is made of a resin having insulation properties and heat resistance. The solder resist functions as a protective coat that protects a substrate main surface by coating the substrate main surface. Specific examples of materials of the solder resist include an epoxy resin and a polyimide resin.

Moreover, in the first manufacturing method and the second manufacturing method, the laser irradiation conditions at the time of forming a projection or protrusion line may include that the laser output is equal to or greater than 5.4 W and the laser oscillation frequency is equal to or greater than 90 kHz. If the laser output is equal to or greater than 5.4 W and the laser oscillation frequency is less than 90 kHz, the accumulated quantity of heat given to one point rises. Therefore, there is fear that damage by heat generated by processing is given to the deep part of the resin insulating layer.

Further, in the first manufacturing method and the second manufacturing method, the laser movement speed (printing speed) may be set to be equal to or greater than 900 mm/s and equal to or less than 1100 mm/s. If the laser movement speed (printing speed) becomes less than 900 mm/s, the speed of forming a projection or protrusion line decreases. As a result, the substrate manufacturing efficiency may decrease. In addition, the accumulated quantity of heat rises by overlap of processing portion. As a result, there is fear that damage by heat generated by processing is given to the deep part of the resin insulating layer. Meanwhile, when the laser movement speed (printing speed) becomes higher than 1100 mm/s, the accumulated heat quantity given to one point becomes too low. Therefore, there is fear that it is not possible to reliably form the projection or protrusion line. That is, in the first manufacturing method and the second manufacturing method, as compared with conventional laser radiation conditions, it may be possible to increase the laser output, increase the laser oscillation frequency and fasten the laser movement speed (printing speed). By doing these, it is possible to stably form a fine projection or protrusion line. Further, it is possible to form a fine projection or protrusion line in a format to thinly cut the surface of the resin insulating layer.

Here, it is possible to form a projection or protrusion line by foaming the resin insulating layer and raising the surface. In this case, when a high temperature of 200° C. or more is added, bubbles are removed and therefore the concavo-convex shape of the projection or protrusion line disappears. By contrast with this, when a fine projection or protrusion line is formed in a method to cut the surface, even in a case where a high temperature of 200° C. or more is added, the concavo-convex shape of the projection or protrusion line is maintained. As a result, it is possible to sufficiently secure the identifying mark visibility.

A material that forms the above-mentioned substrate is not especially limited and is arbitrary. As the substrate material, for example, a resin is suitable. Examples of a suitable resin material include an EP resin (epoxy resin), a PI resin (polyimide resin), a BT resin (bismaleimide-triazine resin) and a PPE resin (polyphenylene ether resin). The substrate material may be a composite material of these resins and glass fibers (such as a glass woven fabric and a glass nonwoven fabric). For example, specific examples of the composite material include a high heat-resistance laminate plate such as a glass-BT composite substrate and a high Tg glass-epoxy composite substrate (such as FR-4 and FR-5). Moreover, the substrate material may be a composite material of the above-mentioned resins and game fibers such as a polyamide fiber. Alternatively, the substrate material may be a resin-resin composite material. This resin-resin composite material is a three-dimensional network fluorine-containing resin base material such as continuously porous PTFE in which a thermosetting resin such as an epoxy resin is included. As another substrate material, for example, it is possible to select various ceramics. Here, the substrate construction is not especially limited. For example, the substrate may be a buildup multilayer wiring substrate having a buildup layer in one side or both sides of a core substrate. Moreover, the substrate may be a coreless wiring substrate without the core substrate.

In the following, one embodiment that is a specific example of the present invention is described in detail on the basis of the drawings.

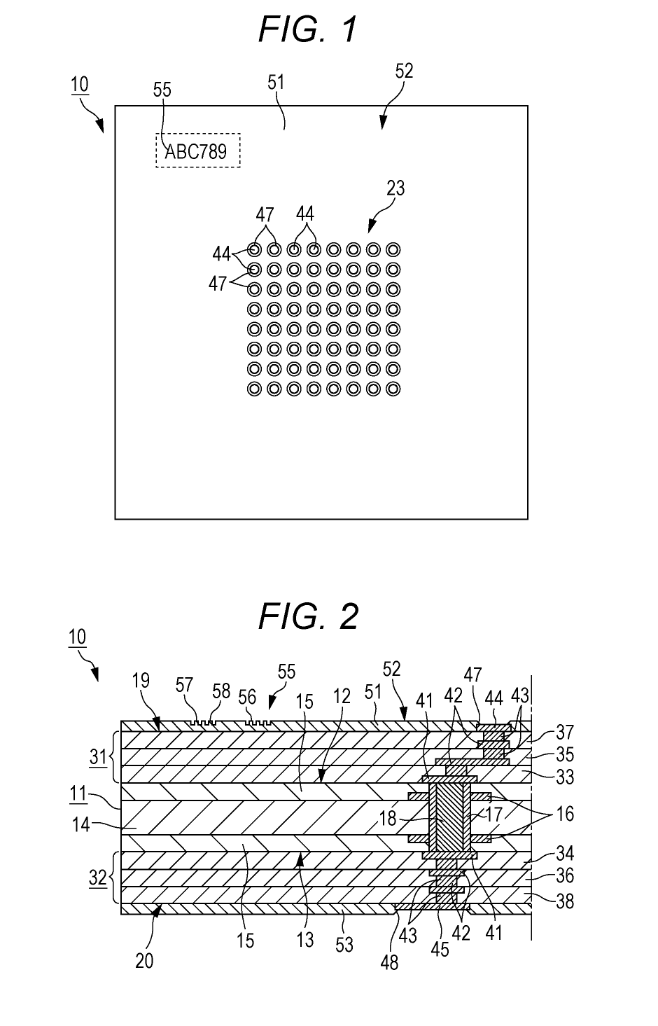

As shown in FIGS. 1 and 2, a wiring substrate 10 of the present embodiment is a substrate to be mounted on an IC chip. The wiring substrate 10 is a buildup multilayer wiring substrate that includes a core substrate 11 of a substantially rectangular plate shape, a main-surface-side buildup layer 31 and a back-side buildup layer 32. The main-surface-side buildup layer 31 is formed on a core main surface 12 (upper surface in FIG. 2) of the core substrate 11. The back-side buildup layer 32 is formed on a core back surface 13 (lower surface in FIG. 2) of the core substrate 11.

The core substrate 11 of the present embodiment is a substantially rectangular plate shape in plan view with 25 mm in length, 25 mm in width and 1.0 mm in thickness. The core substrate 11 includes a substrate 14 made of a glass epoxy, a sub-substrate 15 and a conductor layer 16. The sub-substrate 15 is formed in the upper surface and lower surface of the substrate 14, and is made of an epoxy resin to which an inorganic filler such as a silica filler is added. The conductor layer 16 is similarly formed in the upper surface and lower surface of the substrate 14, and is made of copper.

Moreover, in the core substrate 11, a plurality of through hole conductors 17 are formed so as to penetrate the core main surface 12, the core back surface 13 and the conductor layer 16. The through hole conductor 17 connects and conducts the sides of the core main surface 12 and the core back surface 13 of the core substrate 11, and is electrically connected to the conductor layer 16. Here, for example, the inside of the through hole conductor 17 is filled with a blocking body 18 such as an epoxy resin. Moreover, a conductor layer 41 made of copper is subjected to pattern formation on the core main surface 12 and the core back surface 13 of the core substrate 11. The conductor layer 41 is electrically connected to the through hole conductor 17.

As shown in FIG. 2, the main-surface-side buildup layer 31 has a construction in which three layers of resin insulating layers 33, 35 and 37 made of a thermosetting resin (epoxy resin) and a conductor layer 42 made of copper are alternately laminated. Moreover, a terminal pad 44 is formed in an array manner in a plurality of positions on the surface of the resin insulating layer 37 of the third layer. Further, the surface of the resin insulating layer 37, that is, a substrate main surface 19 of the wiring substrate 10 is almost entirely covered with a solder resist 51. The solder resist 51 of the present embodiment is made of, for example, a resist material colored with blue (manufactured by Hitachi Chemical Co., Ltd. SR7200). Here, the solder resist 51 may be made of resist materials of other colors (such as green) than blue.

An opening 47 that exposes the terminal pad 44 is formed in a predetermined position of the solder resist 51. A plurality of solder bumps (not shown) are arranged on the surfaces of the terminal pads 44. The solder bumps are electrically connected to respective surface connection terminals (not shown) of an IC chip (not shown) with a rectangular plate shape. Here, a region formed with the terminal pad 44 and the solder bump corresponds an IC chip mounting region 23 that can mount an IC chip. The IC chip mounting region 23 is set to the surface of the main-surface-side buildup layer 31. Moreover, via conductors 43 are respectively provided in the resin insulating layers 33, 35 and 37. These via conductors 43 electrically connect the conductor layer 42 and the terminal pad 44 to each other.

The back-side buildup layer 32 has substantially the same construction as the main-surface-side buildup layer 31 described above. That is, the back-side buildup layer 32 has a construction in which three layers of resin insulating layers 34, 36 and 38 made of a thermosetting resin (epoxy resin) and the conductor layer 42 are alternately laminated. A pad 45 electrically connected to the conductor layer 42 through the via conductor 43 is formed in an array manner in a plurality of positions on the lower surface of the resin insulating layer 38 of the third layer. Moreover, the lower surface of the resin insulating layer 38, that is, a substrate back surface 20 of the wiring substrate 10 is almost entirely covered with a solder resist 53. An opening 48 that exposes the pad 45 is formed in a predetermined position of the solder resist 53. A plurality of solder bumps (not shown) to be electrically connected to a mother board which is not shown is arranged on the surface of the pad 45. Further, the wiring substrate 10 shown in FIGS. 1 and 2 is mounted on the mother board which is not shown through the solder bumps.

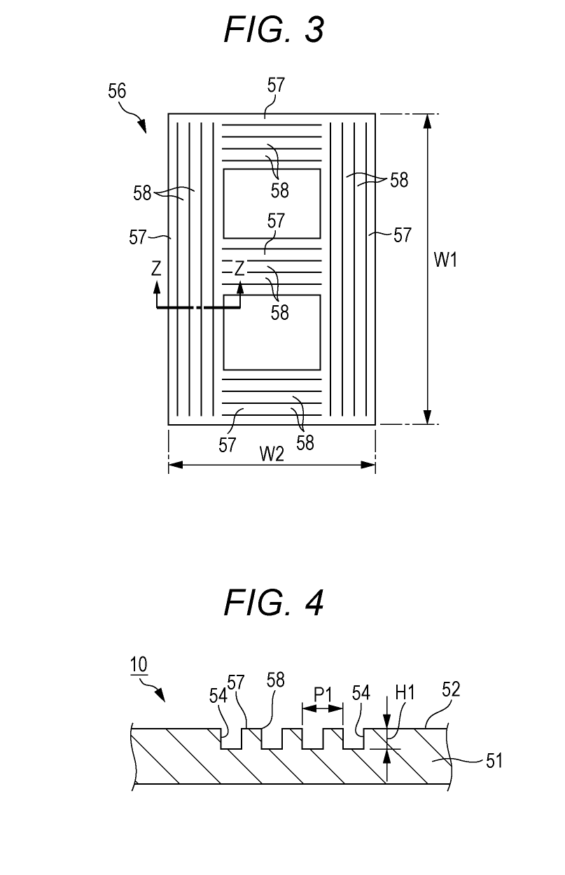

Moreover, as shown in FIG. 1, a marking portion 55 is provided on a front surface 52 of the solder resist 51. The marking portion 55 includes characters (characters of “ABC789” in the present embodiment) indicating a lot number and/or part number, and so on (i.e., identifying mark(s)). The marking portion 55 is arranged in the outer edge portion of the wiring substrate 10 so as to avoid the IC chip mounting region 23. As shown in FIGS. 3 and 4, the character of the marking portion 55 of the present embodiment is about 0.6 mm in vertical width W1 and about 0.45 mm in horizontal width W2. Moreover, height H1 of the marking portion 55 (a projection 58) is set to be equal to or less than a quarter of the thickness of the solder resist 51 (for example, 20 μm), specifically, equal to or greater than 1.5 μm and equal to or less than 6.5 μm. The font of the characters of the marking portion 55 in the present embodiment is a specific font suitable for laser marking.

The specific font used in the present embodiment includes a plurality of straight elements. As shown in FIG. 3, an exemplary character 56 of the font (e.g., the digit of “8”) consists of two elements 57 parallel to the vertical direction and three elements 57 parallel to the horizontal direction. Moreover, as shown in FIGS. 3 and 4, the elements 57 are formed with plural projections 58 that are in parallel at equal intervals. The projections 58 of one element 57 are formed to avoid overlapping the projections 58 of another element 57 (or to avoid the overlap). That is, the projections 58 are a straight shape. Each projection 58 that extends in the horizontal direction and each projection 58 that extends in the vertical direction are formed so as not to be overlapped with each other.

In the present embodiment, formation pitch P1 of the projections 58 is about 25 μm. The projection 58 is formed with by shallowly processing the surface 52 of the solder resist 51 by laser machining processing. To be more specific, a plurality of grooves 54 (see FIG. 4) in parallel at equal intervals are formed in the solder resist 51. The region between adjacent grooves 54 is to be the projection 58. That is, the surface layer portion of the solder resist 51 in which the character 56 of the marking portion 55 is formed is shallowly cut. By doing this, fine concavity and convexity are formed on the surface layer portion of the solder resist 51. When the light is scattered by these concavity and convexity, color development is performed in a state where the surface is discolored in white (white turbidity). By this means, the characters 56 of the marking portion 55 are recognized.

Next, the configuration of a laser machining processing device 61 is described.

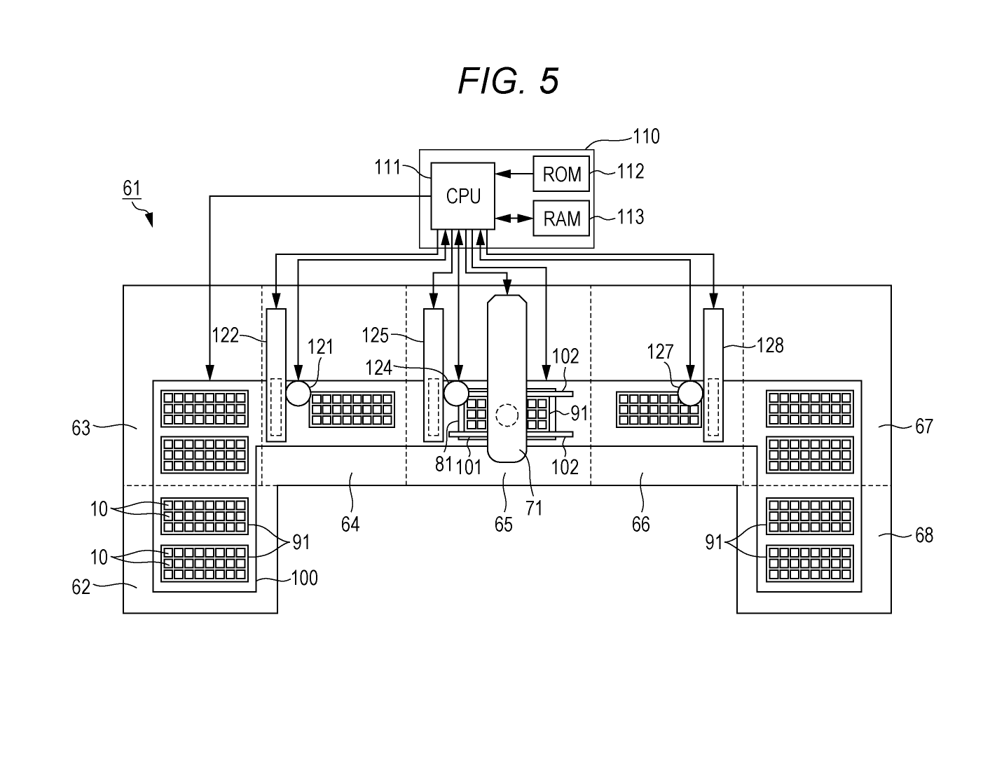

As shown in FIG. 5, the laser machining processing device 61 is formed so as to mark information (the marking portion 55) that shows the type of the wiring substrate 10 or the like to the wiring substrate 10. The laser machining processing device 61 includes a supply unit 62, an unstacking unit 63, a work state recognition unit 64, a laser machining processing unit 65, a printing confirmation unit 66, a stacking unit 67 and an ejection unit 68. Moreover, the laser machining processing device 61 includes a conveyance device 100 and a control device 110. The conveyance device 100 conveys a substrate tray 91 to the supply unit 62, the unstacking unit 63, the work state recognition unit 64, the laser machining processing unit 65, the printing confirmation unit 66, the stacking unit 67 and the ejection unit 68 in order. The control device 110 integrally controls the whole of the laser machining processing device 61.

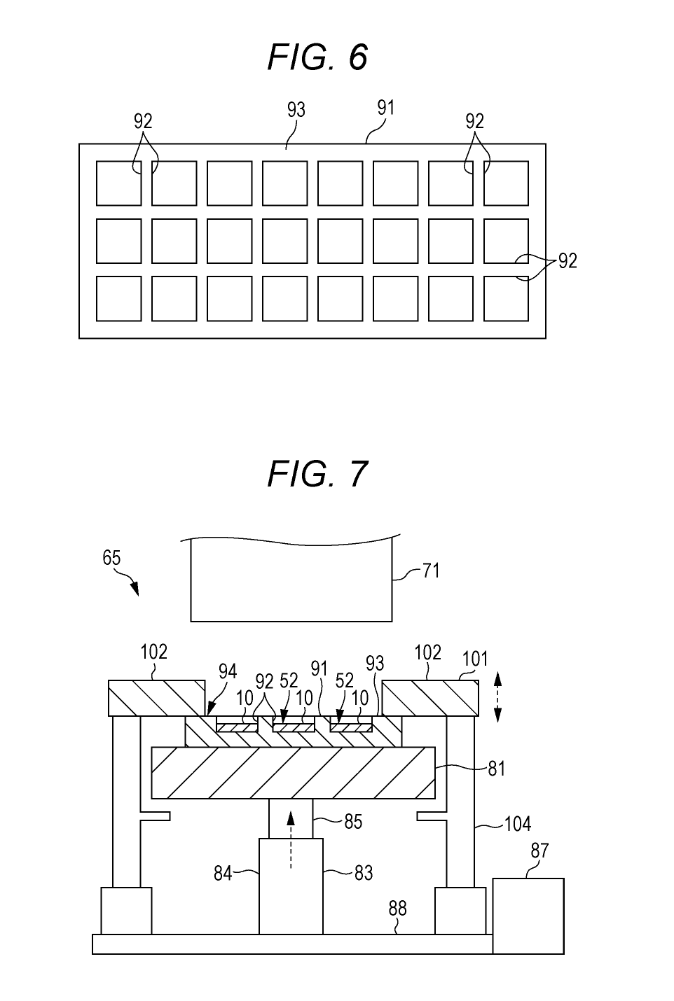

As shown in FIG. 6, for example, the substrate tray 91 forms a substantially rectangular plate shape in plan view with 120 mm in length and 315 mm in width. The substrate tray 91 made of a synthetic resin (for example, PET resin) is a tabular shape. Here, the substrate tray 91 may be made of other materials such as metal (for example, stainless steel). The substrate tray 91 denotes a substrate support unit to support the wiring substrate 10 in a transverse state. In the substrate tray 91 of the present embodiment, a square tray pocket 92 (storage concave portions, in this embodiment, 24 pockets) that stores the wiring substrate 10 is vertically and horizontally arranged along the planar direction. Further, a frame portion 93 that surrounds the tray pocket 92 is formed in the substrate tray 91. This substrate tray 91 is also used as a product shipment tray that stores products at the time of product shipment.

As shown in FIG. 5, in the present embodiment, the substrate trays 91 accumulated in multiple stages are carried into the supply unit 62 of the laser machining processing device 61. These substrate trays 91 store a plurality of wiring substrates 10 before marking processing. Moreover, in the unstacking unit 63, after unstacking the stacked substrate trays 91 one by one, a robot or conveying conveyor or the like installed in the conveyance device 100 carries the substrate trays 91 into the work state recognition unit 64.

A recognition camera 121 and a lighting device 122 or the like are installed in the work state recognition unit 64. The recognition camera 121 takes an image of the wiring substrate 10 in the tray pocket 92 from the upper side of the substrate tray 91. The recognition camera 121 and the lighting device 122 are mechanisms to confirm the work state using the technique of image processing. The recognition camera 121 takes an image of the substrate tray 91 and the wiring substrate 10 conveyed from the unstacking unit 63 to the work state recognition unit 64, from the upper side. The lighting device 122 has a function to irradiate light onto the substrate tray 91 and the wiring substrate 10. The lighting device 122 has a function to adjust the light intensity and/or the irradiation position to uniformly illuminate the wiring substrate 10 in each tray pocket 92 in the substrate tray 91. The recognition camera 121 is connected to the control device 110. The image data taken by the recognition camera 121 is imported in the control device 110. The control device 110 confirms whether the wiring substrate 10 with a correct posture (horizontal posture) is stored in the tray pocket 92, on the basis of the image data. Further, the control device 110 confirms whether the wiring substrate 10 is stored in a state where the position of the marking portion 55 faces to a correct direction (for example, upward).

As shown in FIGS. 5 and 7, a laser irradiation device 71, a stage 81, a tray press unit 101, an alignment camera 124 and a lighting device 125 or the like are installed in the laser machining processing unit 65. The stage 81 supports the substrate tray 91 in a state where a main surface 94 of the substrate tray 91 is directed to the laser irradiation device 71. Moreover, the stage 81 moves in the height direction (vertical direction) while the substrate tray 91 is put on. By this means, the stage 81 maintains the distance between the wiring substrate 10 supported by the substrate tray 91 and the laser irradiation device 71 to a defined value (a value corresponding to the laser focal length). To be more specific, an air cylinder 83 is installed below the stage 81. The air cylinder 83 includes a cylinder body 84 and a piston rod 85 that moves up and down by air pressure. The point of the piston rod 85 is fixed to the stage 81. The piston rod 85 raises the whole of the stage 81 by projecting upward from the cylinder body 84. Further, the cylinder body 84 of the air cylinder 83 is fixed to a base 88 that is moved up and down by an up-and-down robot 87.

The tray press unit 101 is installed between the stage 81 and the laser irradiation device 71. The tray press unit 101 avoids the wiring substrate 10 and presses the main surface 94 of the substrate tray 91 supported by the stage 81. To be more specific, the tray press unit 101 includes two rod-like stopper members 102. These stopper members 102 are arranged so as to extend along the tray conveyance direction (the right and left directions in FIG. 5). The stopper member 102 is arranged in substantially parallel to the main surface 94 of the stage 81. Further, when the stage 81 is moved upward by driving the air cylinder 83, the frame portion 93 of the main surface 94 of the substrate tray 91 is surface-contacted with the stopper member 102 of the tray press unit 101. By this means, the main surface 94 of the substrate tray 91 is pressed by the stopper member 102. As a result, the main surface 94 of the substrate tray 91 is horizontally held. According to this, the upper surface of the wiring substrate 10 (the surface 52 of the solder resist 51) is horizontally held. Further, in a case where the substrate tray 91 is warped, the warp is corrected. Also, in the present embodiment, the stage 81 and the tray press unit 101 are designed such that the angular error of the levelness of the substrate tray 91 is less than 0.1°.

Further, the tray press unit 101 (the stopper member 102) is fixed on the base 88 through a coupling member 104. The tray press unit 101 (the stopper member 102) is coupled with the up-and-down robot 87 through the coupling member 104 and the base 88. When the base 88 moves up and down by driving this up-and-down robot 87, the tray press unit 101 moves in the height direction together with the stage 81 while pressing the main surface 94 of the substrate tray 91. Thus, the substrate tray 91 (the wiring substrate 10) is aligned such that the laser irradiation device 71 focuses on the surface 52 of the wiring substrate 10 supported by the substrate tray 91. Here, the air cylinder 83 and the up-and-down robot 87 are connected to the control device 110 too. The air cylinder 83 and the up-and-down robot 87 are driven and controlled on the basis of a control signal output from the control device 110.

The standardized size of the substrate tray 91 to be used varies depending on the type of the wiring substrate 10. The position (height) of the surface 52 in the wiring substrate 10 varies depending on the storage position and thickness of the wiring substrate 10 in the tray pocket 92 in the substrate tray 91 and the thickness of the substrate tray 91, and so on. Therefore, in a case where the height of the stage 81 and the tray press unit 101 is not corrected, the laser irradiation device 71 does not focus on the surface 52 of the wiring substrate 10. Regarding this, in the present embodiment, information on the thickness of the substrate tray 91 and the position and thickness of the wiring substrate 10 in the tray pocket 92, and so on, is input in the control device 110. The control device 110 corrects the height of the stage 81 and the tray press unit 101 according to the information. As a result of this, the distance between the laser irradiation device 71 and the surface 52 of the wiring substrate 10 is kept constant.

The alignment camera 124 and the lighting device 125 in the laser machining processing unit 65 shown in FIG. 5 are mechanisms to recognize the position of the wiring substrate 10 using the technique of image processing. The alignment camera 124 takes an image of the substrate tray 91 and the wiring substrate 10 conveyed from the work state recognition unit 64 to the laser machining processing unit 65, from the upper side. The lighting device 125 has a function to irradiate light onto the substrate tray 91 and the wiring substrate 10. The lighting device 125 has a function to adjust the light intensity and/or the irradiation position to uniformly illuminate the wiring substrate 10 in each tray pocket 92 in the substrate tray 91. The alignment camera 124 is connected to the control device 110. The image data taken by the alignment camera 124 is imported in the control device 110. The control device 110 acquires position data of the wiring substrate 10 in each tray pocket 92 in the substrate tray 91 on the basis of the image data. The control device 110 controls the laser irradiation device 71 by the use of this position data.

The laser irradiation device 71 is formed to irradiate a laser to each wiring substrate 10 supported by the substrate tray 91. The laser irradiation device 71 includes a laser generation unit (not shown) that generates a laser (YVO₄ laser of a wavelength of 532 nm in the present embodiment), a laser deflection unit (not shown) that deflects the laser and a laser control unit (not shown) that controls the laser generation unit and the laser deflection unit. The laser deflection unit has an optical system combining a lens (not shown) and a reflection mirror (not shown). The laser deflection unit adjusts the irradiation position and focus position of the laser by changing the positions of these lens and reflection mirror. The laser control unit controls the laser irradiation intensity, the laser oscillation frequency and the laser movement speed (printing speed), and so on.

The printing confirmation unit 66 is provided with a mechanism to inspect the printing state of the marking portion 55 using the technique of image processing, specifically, the printing confirmation unit 66 is provided with the inspection camera 127 and the lighting device 128. The inspection camera 127 takes an image of each wiring substrate 10 of the substrate tray 91 conveyed from the laser machining processing unit 65 to the printing confirmation unit 66, from the upper side. A lighting device 128 has a function to irradiate light to the marking portion 55 on the wiring substrate 10. The lighting device 128 has a function to adjust the light intensity and/or the irradiation position to uniformly illuminate the wiring substrate 10 in each tray pocket 92 in the substrate tray 91. The inspection camera 127 is connected to the control device 110. The image data taken by the inspection camera 127 is imported in the control device 110. The control device 110 confirms the printing state of the marking portion 55 of each wiring substrate 10 on the basis of the image data.

In the stacking unit 67, the substrate tray 91 carried from the printing confirmation unit 66 is stacked and arranged in multiple stages in the thickness direction. Subsequently, the substrate trays 91 stacked in predetermined stages are sent to the ejection unit 68 by the conveyance device 100 and ejected from the ejection unit 68 to the outside of the laser machining processing device 61.

The control device 110 may be a known computer including a CPU 111, a ROM 112, a RAM 113 and an input/output port (not shown), and so on. The control device 110 is electrically connected to the laser irradiation device 71, the conveyance device 100, cameras 121, 124 and 127, the lighting devices 122, 125 and 128, the air cylinder 83 and the up-and-down robot 87, and so on. The control device 110 controls these members by various control signals. The CPU 111 of the control device 110 performs various kinds of processing to control the whole of the laser machining processing device 61. The CPU 111 performs computation processing on various control commands according to the processing result. Further, the CPU 111 outputs the control commands as predetermined control signals. The ROM 112 stores a control program to control the laser machining processing device 61, and so on. Moreover, the RAM 113 temporarily stores various kinds of information used for the operation of the laser machining processing device 61.

To be more specific, laser irradiation data to perform laser irradiation is stored in the RAM 113. The laser irradiation data denotes data generated on the basis of CAD data. The CAD data is acquired by converting data of the characters 56 forming the marking portion 55. Moreover, the RAM 113 stores data showing laser irradiation parameters (such as the irradiation position, focus position, irradiation angle, movement speed, lighting intensity, irradiation period and irradiation pitch of the laser) used for the laser irradiation. Further, the RAM 113 stores information on the thickness of the substrate tray 91, the position of the wiring substrate 10 in the tray pocket 92 and the thickness of the wiring substrate 10, and so on.

Next, a manufacturing method of the wiring substrate 10 according to the present embodiment is described.

The wiring substrate 10 of the present embodiment is manufactured by executing a known buildup step on the core main surface 12 and the core back surface 13 of the core substrate 11′. In the present embodiment, a multi-piece wiring substrate yields the wiring substrate 10. In the multi-piece wiring substrate, a plurality of manufacture regions that are the wiring substrates 10 is vertically and horizontally arranged along the planar direction. By a cutting step with respect to the multi-piece wiring substrate, a plurality of divided wiring substrates 10 is yielded at the same time. Subsequently, these wiring substrates 10 are stored in each tray pocket 92 of the substrate tray 91 one by one. Further, the substrate tray 91 stacked in multiple stages is carried into the supply unit 62 of the laser machining processing device 61.

Afterwards, when the worker turns on an operation switch (not shown) of the laser machining processing device 61, processing to mark the marking portion 55 on the wiring substrate 10 is started. To be more specific, the CPU 111 of the control device 110 carries each of the stacked substrate trays 91 into the unstacking unit 63 by driving the conveyance device 100. In the unstacking unit 63, the substrate trays 91 are unstacked one by one. Afterwards, the substrate tray 91 is carried into the work state recognition unit 64.

When the substrate tray 91 is carried into the work state recognition unit 64, the CPU 111 drives the recognition camera 121 and the lighting device 122, and starts the lighting and imaging of the substrate tray 91 and the wiring substrate 10. At this time, the CPU 111 imports image data taken by the recognition camera 121 and performs image processing. As a result of the image processing, the CPU 111 confirms whether the wiring substrate 10 with a correct posture (horizontal posture) is stored in the tray pocket 92 and whether the wiring substrate 10 is stored in a state where the position of the marking portion 55 faces to a correct direction (for example, upward). In a case where it is determined that the posture and direction of each wiring substrate 10 is normal, by driving the conveyance device 100, the CPU 111 carries the substrate tray 91 into the laser machining processing unit 65 and places it on the stage 81.

By contrast, in a case where it is determined that the posture and/or direction of the wiring substrate 10 are abnormal, the CPU 111 notifies the information by the use of an alarm unit (buzzer or lamp) which is not shown. Further, the CPU 111 stops each processing of the laser machining processing device 61 once. Afterwards, after correcting the posture and/or direction of the wiring substrate 10 to a normal state, the worker operates the laser machining processing device 61 again. By this means, the CPU 111 carries the substrate tray 91 into the laser machining processing unit 65 and places it on the stage 81 by driving the conveyance device 100.

In the laser machining processing unit 65, the substrate tray 91 is supported on the stage 81 in a state where the main surface 94 faces to the laser irradiation device 71. Afterwards, the CPU 111 drives the air cylinder 83 and moves the whole of the stage 81 in the height direction. By this means, the stage 81 approaches the stopper member 102 of the tray press unit 101. At this time, the frame portion 93 of the main surface 94 of the substrate tray 91 surface-contacts to the stopper member 102 of the tray press unit 101. By this means, the main surface 94 of the substrate tray 91 is pressed by the stopper member 102 while avoiding the wiring substrate 10. As a result of this, the levelness of the main surface 94 of the substrate tray 91 is maintained. Further, the warp of the substrate tray 91 is corrected.

Further, the CPU 111 drives the up-and-down robot 87 and moves the stage 81 and the tray press unit 101 in the height direction while pressing the main surface 94 of the substrate tray 91. By this movement, the distance between the wiring substrate 10 supported by the substrate tray 91 and the laser irradiation device 71 is maintained to a value defined in advance (a value corresponding to the laser focal length).

Afterwards, the CPU 111 drives the alignment camera 124 and the lighting device 125, and starts the lighting and imaging of the substrate tray 91 and the wiring substrate 10. At this time, the CPU 111 imports data of an image taken by the alignment camera 124 and performs image processing. As a result of the image processing, the CPU 111 acquires position data of the wiring substrate 10 in each tray pocket 92 in the substrate tray 91.

The planar part of each tray pocket 92 is larger than the wiring substrate 10. Therefore, there is a slight backlash between the inner wall surface of the tray pocket 92 and the side surface of the wiring substrate 10 stored in the tray pocket 92. Because of this backlash (interspace), the wiring substrate 10 is stored in the tray pocket 92 while being shifted in the horizontal direction. The CPU 111 understands the accurate position of each wiring substrate 10 (the marking portion 55) on the basis of the position data.

Afterwards, the CPU 111 drives the laser irradiation device 71 on the basis of the above-mentioned position data or the like. A laser is irradiated to each wiring substrate 10 by this laser irradiation device 71 and the surface 52 of the solder resist 51 is marked. By this means, the marking portion 55 is formed on the surface 52 of the solder resist 51.

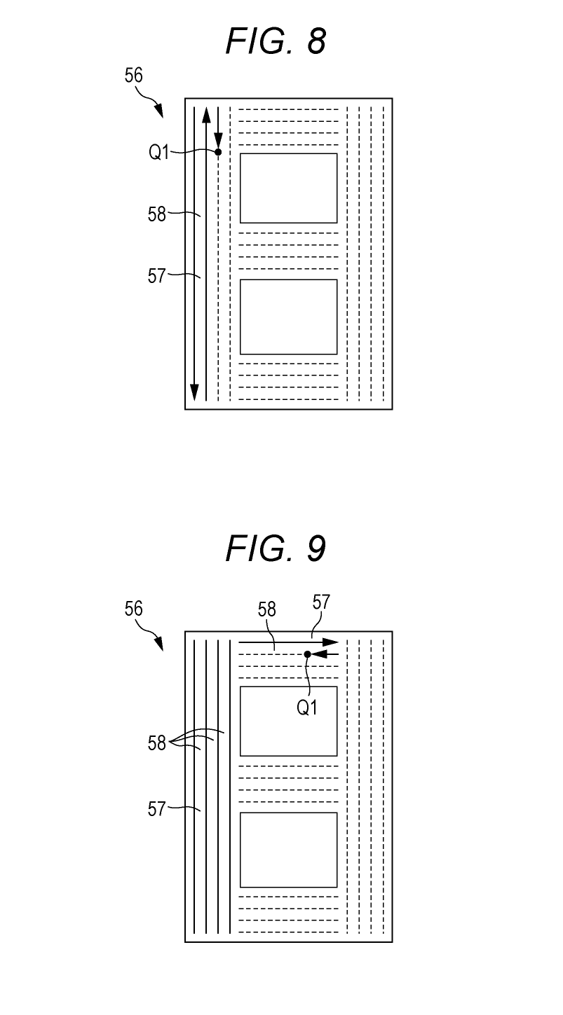

Specifically, the laser irradiation device 71 irradiates the laser while focusing on the surface 52 of the solder resist 51. By this laser irradiation, the laser irradiation device 71 forms the plurality of grooves 54 in parallel at equal intervals. As a result, the region between adjacent grooves 54 is the projection 58. One element 57 is formed with a plurality of projections 58 in parallel at equal intervals. At this time, since adjacent projections 58 in one element 57 are unicursally formed, laser irradiation point Q1 is scanned while alternately reversing the scanning direction (see FIG. 8). Subsequently, at the timing when the laser scanning in one element 57 is terminated, the laser irradiation device 71 (the CPU 111) stops the laser irradiation once. Further, the laser irradiation device 71 (the CPU 111) moves to the formation position of another element 57 that is the closest to the stop position, and restarts the laser irradiation. By this means, the laser irradiation device 71 (the CPU 111) forms another element 57 with the plurality of projections 58 in parallel at equal intervals (see FIG. 9). At this time, the laser irradiation device 71 (the CPU 111) irradiates a laser to such that the plurality of newly formed projections 58 in parallel at equal intervals is not overlapped with the plurality of projections 58 in the element 57 having already been formed (i.e., so as to avoid the overlap). By repeating the similar laser irradiation, the plurality of elements 57 of each character 56 forming the marking portion 55 are formed.

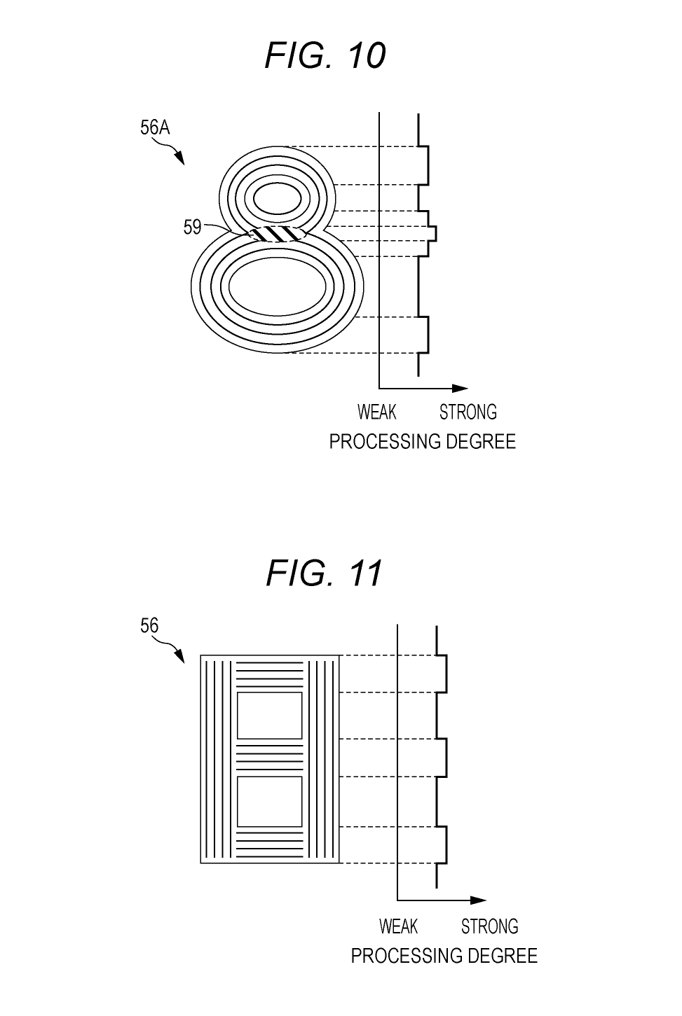

As shown in FIGS. 10 and 11, the character 56 (of a private font) is made instead of a normal rounded printing character 56A (of a normal rounded printing font) in the present embodiment. That is, an intersection 59 (overlapped processing portion) is removed by controlling a laser light path according to the character 56 (and the private printing font). Thus, by using the private printing font, the characters 56 of the marking portion 55 are formed in uniform processing degree on the surface 52 of the solder resist 51.

In the present embodiment, as laser irradiation conditions in the laser irradiation step, the laser output is set to 5.8 W, the laser oscillation frequency is set to 110 kHz and the laser movement speed (printing speed) is set to 1000 mm/s. Moreover, the laser spot diameter is set to the lower limit value (for example, about 5 μm) on the specification of the laser irradiation device 71.

Here, in the case of conventional color development, as laser irradiation conditions, the laser output is set to 1.5 W, the laser oscillation frequency is set to 45 kHz and the laser movement speed (printing speed) is set to 700 mm/s. Further, in the case of conventional surface layer separation, as laser irradiation conditions, the laser output is set to 2.7 W, the laser oscillation frequency of laser L1 is set to 45 kHz and the laser movement speed (printing speed) is set to 700 mm/s.

That is, in the present embodiment, as compared with the case of the conventional surface layer separation, the laser output is increased more than twice, the laser oscillation frequency is increased more than twice and the laser scanning movement speed (printing speed) is fastened more than 1.5 times. By this means, the accumulated heat quantity given to one point by laser machining processing decreases. Therefore, the influence of a caloric effect remains in the surface layer portion of the solder resist 51. As a result, the surface 52 is shallowly processed. Moreover, by one processing on the laser irradiation conditions described above, there is a possibility that it is not possible to acquire sufficient concavity and convexity required for color development of the marking portion 55 (each 58). Therefore, in the present embodiment, the processing frequency is increased and the laser machining processing is performed two or more times. By this means, the fine projection 58 (concavity and convexity) having a height of about 1.5 μm to 6.5 μm is formed. To be more specific, the laser machining processing is thoroughly performed on all of the elements 57 that form the characters of the marking portion 55. Afterwards, according to the processing order, the laser machining processing is performed two or more times in order from the first element 57 along the processing portion. Here, the number of executions of the laser irradiation with respect to respective projections 58 that form each element 57 is mutually identical, for example. By such laser machining processing, the characters of the marking portion 55 are formed (printed) on the surface 52 of the solder resist 51.

After the marking portion 55 is formed, the CPU 111 conveys the substrate tray 91 to the printing confirmation unit 66 by driving the conveyance device 100. Afterwards, the CPU 111 drives the inspection camera 127 and the lighting device 128, and implements the lighting and imaging of the wiring substrate 10. At this time, the CPU 111 imports data of an image taken by the inspection camera 127 and performs image processing. The CPU 111 recognizes the characters of the marking portion 55 printed on each wiring substrate 10, from the result of the image processing. The CPU 111 estimates whether the characters of the marking portion 55 are normally printed. Here, it is estimated whether there is a defect such as in a lack and/or a thin part in the characters (printing estimation). In a case where it is estimated to be normal without defects, the CPU 111 carries the substrate tray 91 into the stacking unit 67 by driving the conveyance device 100. By contrast, in a case where it is estimated that there is a defect in the printing, the CPU 111 notifies the information by the use of an alarm unit (buzzer or lamp) which is not shown. Further, the CPU 111 removes the wiring substrate 10 with abnormality from the tray pocket 92 of the substrate tray 91 by a robot (not shown) or the like of the conveyance device 100. Also, an operation of removing the wiring substrate 10 may be performed by the worker. Moreover, here, the wiring substrate 10 having the marking portion 55 that is normally printed may be prepared in advance and the wiring substrate 10 may be input in an empty tray pocket 92.

Further, the CPU 111 stacks and arranges the substrate tray 91 in the stacking unit 67 in multiple stages in the thickness direction by driving the conveyance device 100. Further, the CPU 111 sends each of the substrate trays 91 stacked in predetermined stages to the ejection unit 68 by the conveyance device 100 and conveys it from the ejection unit 68 to the outside of the laser machining processing device 61. Through the above steps, the marking processing of the marking portion 55 is completed and the wiring substrate 10 shown in FIG. 1 is manufactured.

Therefore, according to the present embodiment, it is possible to acquire the following effects.

(1) In the present embodiment, one element is formed by irradiating a laser. Regarding this element, another element is formed so as not to be overlapped with the plurality of projections 58 forming this element 57 including the plurality of projections 58 in parallel at equal intervals (i.e., so as avoid the overlap). Another element includes the plurality of projections 58 in parallel at equal intervals. Further, the character 56 including these plural elements 57 is formed on the surface 52 of the solder resist 51.

In a case where each character 56 of the marking portion 55 is formed with such the font, the plurality of projections 58 form fine concavity and convexity on the surface of each element 57. Further, light is scattered by the concavity and convexity. As a result, it is possible to sufficiently secure the visibility of each character 56. Moreover, there is no overlapping processing portion between the elements 57. Therefore, the concavo-convex processing is applied to a shallow part of the surface 52 of the solder resist 51. Therefore, damage to the deep part of the solder resist 51 due to heat generated by processing is avoided (or suppressed). Therefore, in a case where the marking portion 55 is formed on the surface 52 of the solder resist 51, it is possible to avoid (or suppress) the decline in the functions (insulation properties and heat resistance) of the solder resist 51. As a result, it is possible to secure the reliability of the wiring substrate 10.

Moreover, in the present embodiment, a special design to embed a metallic layer as a base member is not required unlike the conventional technique of printing surface separation. Therefore, it is possible to efficiently manufacture the wiring substrate 10 with high reliability at low cost.

(2) In the present embodiment, the plurality of projections 58 in parallel at equal intervals is formed by irradiating a laser in two or more batches. When the laser is irradiated in two or more batches in this way, the accumulated heat quantity given to the processing portion of the marking portion 55 decreases. Therefore, it is possible to avoid (or suppress) the damage to the deep part of the solder resist 51 due to heat generated by processing and reliably form the plurality of projections 58 on the surface layer portion.

Moreover, in the present embodiment, the plurality of grooves 54 is formed in a format that cuts the surface 52 of the solder resist 51. Further, the projection 58 is formed in the region between adjacent grooves 54. In this case, even when a high temperature of 200° C. or more is added at the time of mounting an IC chip or the like, concavity and convexity are left on the surface 52. Therefore, it is possible to avoid (or suppress) the disappearance of color development caused in a case where the marking portion is formed by the conventional color development technique. As a result, it is possible to sufficiently secure the visibility of the marking portion 55.

(3) In the present embodiment, laser irradiation is repeatedly performed on the plurality of the projections 58 of the element 57. Further, the number of executions of laser irradiation with respect to each projection 58 is mutually identical. By repeating the laser irradiation in this method, it is possible to reliably form the projections 58 with sufficient height. Moreover, by causing the same number of executions of the laser radiation on each projection 58, it is possible to reliably form the projections 58 in the uniform processing degree. Therefore, it is possible to avoid (or suppress) that it is difficult to partially see the element 57 that forms the character 56. As a result, it is possible to accurately recognize the characters of the marking portion 55.

(4) In the present embodiment, each projection 58 that forms the element 57 is formed to have a height equal to or greater than 1.5 μm and equal to or less than 6.5 μm. When the projections 58 becomes less than 1.5 μm, the visibility of the character 56 decreases. Moreover, when the projection 58 becomes greater than 6.5 μm, the influence of laser machining processing heat on the solder resist 51 increases, and there is fear that the functions (insulation properties and heat resistance) of the solder resist 51 decline. Therefore, when the height of the projection 58 is equal to or greater than 1.5 μm and equal to or less than 6.5 μm, it is possible to secure the reliability of the wiring substrate 10.

(5) In the present embodiment, each projection 58 that forms the elements 57 is formed in a linear shape. In this case, it is possible to form the plurality of projections 58 in parallel at equal intervals, in a relatively easy and accurate manner. Moreover, it is possible to uniformly form each element 57 of each character 56 in the same processing degree. Therefore, it is possible to sufficiently secure the appearance quality of the wiring substrate 10.

(6) In the present embodiment, the marking portion 55 is formed by shallowly cutting the surface 52 of the solder resist 51. In a thin wiring substrate, the thickness of the solder resist 51 becomes thin. The wiring substrate with a thickness of about 10 μm has been put to practical use. Even for such a thin wiring substrate, it is possible to form the marking portion 55 while securing the function of the solder resist 51.

Here, the embodiment of the present invention may be changed as follows.

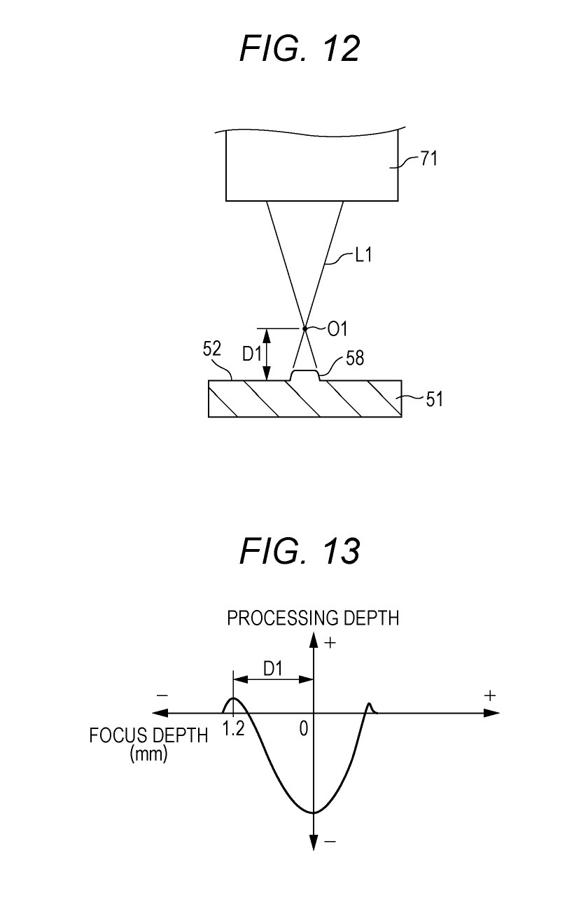

In the above-mentioned embodiment, the plurality of projections 58 is formed by irradiating a laser and shallowly cutting the surface layer portion of the solder resist 51. It is not limited to this, and a plurality of discolored projections 58 may be formed by foaming and raising the surface 52 of the solder resist 51 by irradiating the laser to the surface layer portion of the solder resist 51. In this case, as shown in FIG. 12, focus O1 is set such that distance D1 from the surface 52 of the solder resist 51 is in a range of 1.2 mm±0.25 mm. Moreover, as laser irradiation conditions, the output of laser L1 is set to 2.7 W, the oscillation frequency of laser L1 is set to 20 kHz and the movement speed (printing speed) of laser L1 is set to 500 mm/s.

FIG. 13 is a graph showing the relationship between the focus depth and processing depth of laser L1. In FIG. 13, the focus depth becomes a negative value in a case where focus O1 shifts to the optical source side. Meanwhile, the focus depth becomes a positive value in a case where focus O1 shifts to the internal side of the solder resist 51. Moreover, the processing depth becomes a positive value in a case where the surface 52 of the solder resist 51 rises. The processing depth becomes a negative value in a case where the surface 52 is concave.

As shown in FIG. 13, when focus O1 of laser L1 is shifted to the optical source side only by distance D1 and the laser is irradiated, the surface layer portion of the solder resist 51 is foamed. When a bubble is the confined in the foam part, the projection 58 is formed. When the projection 58 is formed in this method, light is scattered by the foaming bubble confined in the projections 58. Therefore, the marking portion 55 has a white turbid appearance as compared with the surroundings. As a result, it is possible to sufficiently secure the visibility.

Moreover, in a case where the surface 52 of the solder resist 51 is raised by laser irradiation, it is possible to form the marking portion 55 regardless of the existence or nonexistence of a conductor layer (wiring pattern) in the interface between the resin insulating layer 37 and the solder resist 51. According to this, a region in which the marking portion 55 can be formed in the surface 52 of the solder resist 51 becomes wide. As a result, it is possible to print more information as the marking portion 55.

In the above-mentioned embodiment, the marking portion 55 is formed by irradiating laser L1 to the solder resist 51. Instead of this, the marking portion may be formed in another layer of the wiring substrate 10. For example, the marking portion may be formed by omitting the solder resist 51 and irradiating laser L1 to the resin insulating layer 37. In this case, the resin insulating layer 37 is a resin insulating layer of the outermost layer.

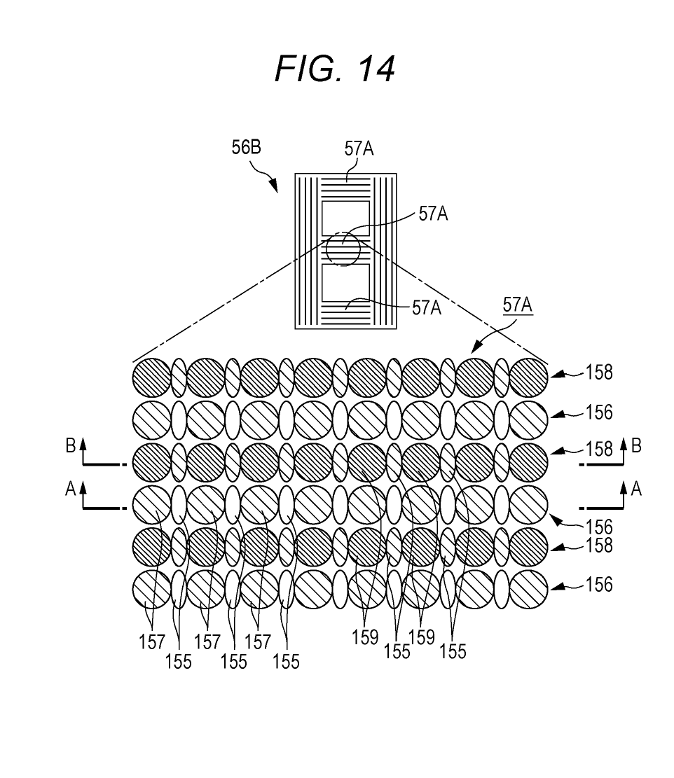

In the above-mentioned embodiment, the plurality of projections 58 is formed on the surface 52 of the solder resist 51 by laser irradiation. It is not limited this, and, for example, the wiring substrate of the present invention may have a construction like the wiring substrate 10A of another embodiment shown in FIGS. 14 to 16.

Similar to the exemplary character 56 shown in FIG. 3, the exemplary character 56B of this wiring substrate 10A includes the plurality of straight elements 57A. As shown in FIG. 14 or the like, the element 57A is formed with a plurality of protrusion lines 158 in parallel at equal intervals. Each protrusion line 158 is formed with a plurality of mutually sequential protrusion portions 159. A small protrusion portion 155 is positioned between the plurality of protrusion portions 159 (see FIGS. 14 and 16).

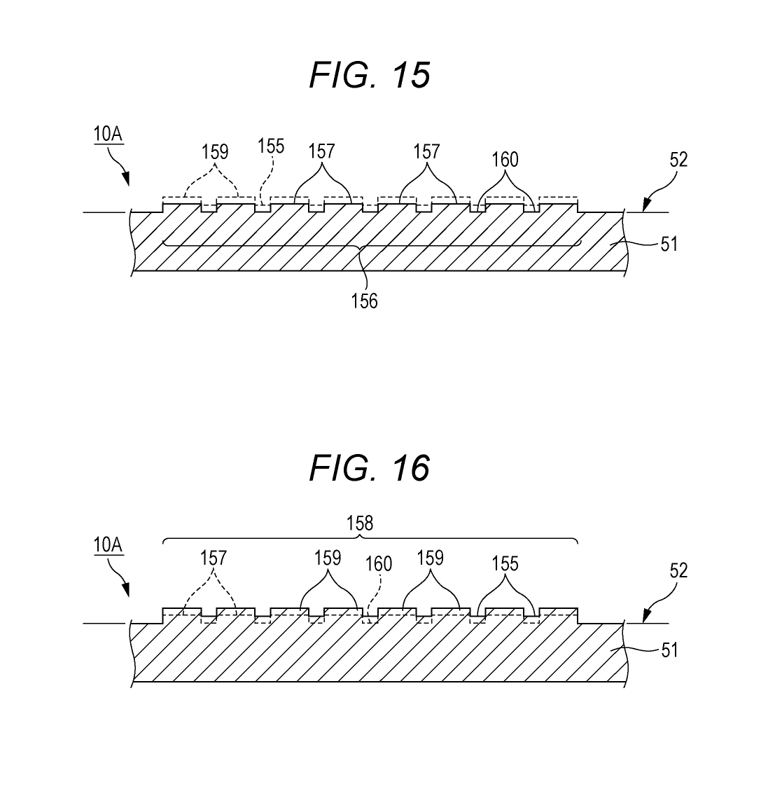

When the height of the surface 52 of the solder resist 51 is used as a reference, the position of the upper surface of the protrusion portion 159 is slightly higher than the position of the upper surface of the small protrusion portion 155. Moreover, as shown in FIG. 14 or the like, a hollow line 156 is arranged between adjacent protrusion lines 158 in the element 57A. Each hollow line 156 is formed with a plurality of mutually sequential small protrusion portions 157. The hollow portion 160 is positioned between the plurality of small protrusion portions 157 (see FIGS. 14 and 15).

In plan view, the area of the hollow portion 160 is smaller than the areas of the small protrusion portion 157 and the protrusion portion 159. Also, in FIG. 14, hatching that shows a part discolored in white (white turbidity) is attached to the protrusion portion 159 and the small protrusion portions 155, 157. Meanwhile, since the hollow portion 160 is not a discolored part, the hatching is not attached.

In the case of the character 56B of the above-mentioned wiring substrate 10A, the protrusion line 158 of one element 57A is formed so as not to be overlapped with the protrusion line 158 of another element 57A (or so as to avoid the overlap). That is, the protrusion line 158 that extends straight in the horizontal direction and the protrusion line 158 that extends straight in the vertical direction are formed so as not to be overlapped with each other (or so as to avoid the overlap).

Further, it is possible to form such the character 56B by laser irradiation using the laser irradiation device 71 shown in the above-mentioned embodiment. To be more specific, the laser irradiation device 71 (the CPU 111) forms the plurality of protrusion lines 158 in parallel at equal intervals by scanning and irradiating a laser to the surface 52 of the solder resist 51. At this time, the laser irradiation device 71 (the CPU 111) forms the hollow lines 156 in parallel at equal intervals, between adjacent protrusion lines 158, by scanning and irradiating the laser. By this means, one element 57A is formed. At the timing when the formation of one element 57A is finished, the laser irradiation device 71 (the CPU 111) stops the laser irradiation once. Subsequently, the laser irradiation device 71 (the CPU 111) shifts to the formation position of another element 57A closest the stop position and restarts the laser irradiation. By this means, the laser irradiation device 71 (the CPU 111) irradiates the laser such that the plurality of protrusion lines 158 and the plurality of hollow lines 156 that are newly formed and that are in parallel at equal intervals are not overlapped with the plurality of protrusion lines 158 and the plurality of hollow lines 156 in element 57A having already been formed (or so as to avoid the overlap). By repeating the similar laser irradiation, the plurality of elements 57A of each character 56B that forms the marking portion is formed. As a result of the above, it is possible to efficiently manufacture the wiring substrate 10A with high reliability at low cost.

Next, other technical ideas understood from the above-mentioned embodiment than the technical ideas described in the claims are enumerated as follows.

(1) A substrate manufacturing method in which an output of a laser irradiated at the time of forming the projection or the protrusion line is equal to or greater than 5.4 W in the first manufacturing method and the second manufacturing method.

(2) A substrate manufacturing method in which an oscillation frequency of a laser irradiated at the time of forming the projection or the protrusion line is equal to or greater than 90 kHz in the first manufacturing method and the second manufacturing method.

(3) A substrate manufacturing method in which a movement speed (printing speed) of a laser irradiated at the time of forming the projection or the protrusion line is equal to or greater than 900 mm/s and equal to or less than 1100 mm/s in the first manufacturing method and the second manufacturing method.

(4) A substrate manufacturing method in which, in the step of irradiating the laser, the plurality of projections or the plurality of protrusion lines is formed by cutting a surface of a resin insulating layer by irradiating a laser to a surface layer portion of the resin insulating layer of an outermost layer in the first manufacturing method and the second manufacturing method.

(5) A laser machining device including: a substrate support unit configured to support a substrate in a transverse state; a laser irradiation device configured to irradiate a laser to the substrate supported by the substrate support unit; a stage configured to maintain a distance between the substrate supported by the substrate support unit and the laser irradiation device to a defined value decided in advance, by supporting the substrate support unit in a state where a main surface faces to the laser irradiation device and moving the substrate support unit in a height direction; and a press unit configured to be arranged between the stage and the laser irradiation device and pressing the main surface of the substrate support unit supported by the stage while avoiding the substrate.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for manufacturing a substrate with an identifying mark having a plurality of elements, the substrate having a laminated construction including a plurality of resin insulating layers, the method comprising:
forming a first element of the identifying mark by irradiating the substrate with a laser to create a first plurality of projections in parallel at equal intervals; and
forming another element of the identifying mark by irradiating the substrate with the laser to create a second plurality of projections in parallel at equal intervals that do not overlap the first plurality of projections.

2. The method for manufacturing a substrate according to claim 1,
wherein an outermost resin insulating layer of the substrate has a surface layer portion; and
wherein irradiating the substrate with the laser includes irradiating the surface layer portion of the outermost resin insulating layer to foam the surface layer portion to raise the first plurality of projections and the second plurality of projections.

3. The method for manufacturing a substrate according to claim 1, further comprising irradiating the substrate with the laser a second time to create the first plurality of projections and the second plurality of projections.

4. The method for manufacturing a substrate according to claim 1,
further comprising repeatedly irradiating the substrate with the laser to create the first plurality of projections and the second plurality of projections,
wherein the same number of executions of irradiating the substrate with the laser is performed to create each of the first plurality of projections and the second plurality of projections.

5. The method for manufacturing a substrate according to claim 1, wherein the first plurality of projections and the second plurality of projections have a linear shape.

6. The method for manufacturing a substrate according to claim 1, wherein a height of the first plurality of projections and the second plurality of projections is equal to or greater than 1.5 μm and equal to or less than 6.5 μm.

7. The method for manufacturing a substrate according to claim 1, wherein an outermost resin insulating layer is a colored solder resist.

8. A method for manufacturing a substrate with an identifying mark having a plurality of elements, the substrate having a laminated construction including a plurality of resin insulating layers, the method comprising:
forming a first element of the identifying mark by irradiating the substrate with a laser to create a first plurality of protrusion lines in parallel at equal intervals including a plurality of sequential protrusion portions; and
forming another element of the identifying mark by irradiating the substrate with the laser to create a second plurality of protrusion lines in parallel at equal intervals that do not overlap the first plurality of protrusion lines.

9. The method for manufacturing a substrate according to claim 8,
wherein an outermost resin insulating layer of the substrate has a surface layer portion; and
wherein irradiating the substrate with the laser includes irradiating the surface layer portion of the outermost resin insulating layer to foam the surface layer portion to raise the first plurality of protrusion lines and the second plurality of protrusion lines.

10. The method for manufacturing a substrate according to claim 8, further comprising irradiating the substrate with the laser a second time to create the first plurality of protrusion lines and the second plurality of protrusion lines.

11. The method for manufacturing a substrate according to claim 8,
further comprising repeatedly irradiating the substrate with the laser to create the first plurality of protrusion lines and the second plurality of protrusion lines,
wherein the same number of executions of irradiating the substrate with the laser is performed to create each of the first plurality of protrusion lines and the second plurality of protrusion lines.

12. The method for manufacturing a substrate according to claim 8, wherein the first plurality of protrusion lines and the second plurality of protrusion lines have a linear shape.

13. The method for manufacturing a substrate according to claim 8, wherein a height of the first plurality of protrusion lines and the second plurality of protrusion lines is equal to or greater than 1.5 μm and equal to or less than 6.5 μm.

14. The method for manufacturing a substrate according to claim 8, wherein an outermost resin insulating layer is a colored solder resist.
